(19) United States
(12) Patent Application Publication
(10) Pub. No.: US 2026/0096657 A1
(43) Pub. Date: Apr. 9, 2026

(54) BACKREST COVER AND FOAM MOUNTING STRUCTURE ADAPTED FOR LUMBAR MASSAGE FUNCTION

(71) Applicant: Adient (Chongqing) Automotive Components Co., Ltd., Chongqing (CN)

(72) Inventors: Jie TANG, Chongqing (CN); Shaobin XU, Chongqing (CN); Tairen PAN, Chongqing (CN); Wei JIA, Chongqing (CN); Yi XIN, Chongqing (CN)

(21) Appl. No.: 19/351,451

(22) Filed: Oct. 7, 2025

(30) Foreign Application Priority Data
Oct. 8, 2024 (CN) 202422426918.4

(51) Int. Cl. A47C 7/46; A61H 7/00

(52) U.S. Cl. CPC A47C 7/46; A61H 7/004; A61H 2201/1623; A61H 2203/0431; A61H 2205/081

(57) ABSTRACT

A backrest cover and foam mounting structure adapted for a lumbar massage function may have a backrest foam with a recessed area. The recessed area may be provided with two strip-shaped through grooves. The two strip-shaped through grooves may be each used to accommodate a massage push arm. A front side of the backrest foam may be provided with a wear-resistant fabric. The wear-resistant fabric may have a covering layer covering a surface of the backrest foam. An elastic layer may be provided on a rear side of the covering layer. The elastic layer may be arranged in a folded manner within the recessed area. The wear-resistant fabric may be pushed outward by the massage push arms in the strip-shaped through grooves. The elastic layer may be able to be forced to stretch outward, enabling the wear-resistant fabric to protrude outward.

### TECHNICAL FIELD

An automobile seat, and in particular a backrest cover and foam mounting structure adapted for a lumbar massage function for an automobile seat is provided.

### BACKGROUND

To improve the seating comfort of automobile seats, some manufacturers have chosen to integrate massage devices into the seat backrests. While a user is seated, the massage device can massage the user's lumbar area to relieve fatigue from prolonged sitting and enhance the driving experience. In conventional massage technical solutions, massage airbags and mechanical massagers are usually adopted and integrated into the lumbar areas of the backrests. The airbag massage uses a soft-textured air cushion acting on the user's lumbar and back areas, resulting in low massage intensity and poor massage effect, making it difficult to achieve full and deep relaxation of the user's body. Most mechanical massagers massage the user's back by means of a rotatable massage component that directly presses against the user's back. Although the massage intensity is greater than that of airbag massage, it also has the disadvantages of large size and complex structure.

In view of the shortcomings of the conventional technology, the applicant intends to develop a massage device that can simulate kneading, tapping and massage techniques. Its core technology is that a backrest needs to be internally integrated with two massage push arms that can move up and down along the height direction of the backrest. After the end portions of the massage push arms act on the user's waist, the massage push arms are controlled to swing in a mechanical transmission manner to provide kneading and tapping massage. Alternatively, after the end portions of the massage push arms act on the user's waist, the massage push arms are controlled to move up and down by means of a lifting structure to provide therapeutic (such as Tui Na) message. In this research and development concept, it should be required that when the massage function is not enabled, the massage push arms can be retracted and stored in the backrest, remaining in a non-protruding state to avoid causing discomfort to the user during normal seating; when the massage function is enabled, the massage push arms need to press against the inner side of a cover at the front of the backrest, and when the massage push arms are working, the cover may also form a slight outward bulge. Therefore, what kind of cover and foam mounting method to use to better ensure the stable operation and integrated installation of the massage device has become a technical problem that needs to be overcome urgently.

### SUMMARY

A backrest cover and foam mounting structure adapted for a lumbar massage function, which is intended to better accommodate massage push arms and ensure their stable operation is provided.

A backrest cover and foam mounting structure adapted for a lumbar massage function comprising a backrest foam wherein a front surface of the backrest foam is provided with a recessed area, the recessed area is provided with two strip-shaped through grooves extending in a height direction of a backrest, and the two strip-shaped through grooves are each used to accommodate a massage push arm.

A front side of the backrest foam is provided with a wear-resistant fabric, the wear-resistant fabric comprises a covering layer covering the surface of the backrest foam, an elastic layer is provided on a rear side of the covering layer, and the elastic layer is arranged in a folded manner within the recessed area. When the wear-resistant fabric is pushed outward by the massage push arms in the strip-shaped through grooves, the elastic layer is able to be forced to stretch outward, enabling the wear-resistant fabric to protrude outward.

With the above structure, when the massage function is enabled, the massage push arms pass through the strip-shaped through grooves and the elastic layer of the annular structure and act on the inner side of the covering layer. The inner side of the covering layer is pushed forward by the massage push arms, which causes the elastic layer to stretch outward. The positions of the covering layer corresponding to the massage push arms can adaptively protrude outward without any feeling of pulling, so that it can be ensured that the massage push arms stably perform massage operations such as kneading, tapping, and therapeutic (such as Tui Na) massage.

Preferably, the elastic layer is an annular structure and is arranged along a circumferential direction of the recessed area.

Preferably, the elastic layer has at least two folding layers, the outermost folding layer is connected to the covering layer, the innermost folding layer is connected with transition sections, and the transition sections are channel structures and are connected to groove walls of the strip-shaped through grooves.

Preferably, an inner connecting layer is provided at an end of the transition section away from the elastic layer, and the inner connecting layer covers an inner surface of the backrest foam.

Preferably, a steel wire is embedded in the backrest foam, and a circumferential edge of the covering layer is anchored on the steel wire.

Preferably, the recessed area is a rectangular groove that is downwardly concave. Preferably, the length of the strip-shaped through groove is smaller than the length of the recessed area.

Preferably, a mesh fabric and a sealing plate are provided between the inner connecting layer and the inner surface of the backrest foam.

Preferably, the wear-resistant fabric has elasticity.

Compared with the prior art, the device has the following beneficial effects:

By adopting the backrest cover and foam mounting structure adapted to the lumbar massage function, the massage device being arranged inside the backrest and at a position on the rear side of the wear-resistant fabric, when the massage device is not in operation, the massage push arms are retracted and stored in the strip-shaped through grooves and do not press against the inner side of the wear-resistant fabric. At this time, it can be ensured that the covering layer is in a flat state, which not only has high appearance quality, but also provides good comfort for users to lean on the seat back normally without any discomfort. When the massage function is enabled, the massage push arms pass through the strip-shaped through grooves and the elastic layer of the annular structure and act on the inner side of the covering layer. The inner side of the covering layer is pushed forward by the massage push arms, which causes the elastic layer to stretch outward. The positions of the covering layer corresponding to the massage push arms can adaptively protrude outward without any feeling of pulling, so that it can be ensured that the massage push arms stably perform massage operations such as kneading, tapping, and therapeutic (such as Tui Na) massage.

### BRIEF DESCRIPTION OF THE DRAWINGS

FIG. 1 is a schematic structural view of a backrest foam;

FIG. 2 is a schematic structural view of a backrest foam;

FIG. 3 is a schematic structural view of a wear-resistant fabric;

FIG. 4 is a cross-sectional view of the wear-resistant fabric;

FIG. 5 is a cross-sectional view;

FIG. 6 is a partial enlarged view of portion A in FIG. 5; and

FIG. 7 is a reference view the backrest foam in a usage state.

### DETAILED DESCRIPTION OF THE EMBODIMENTS

It is to be understood that the device may assume various alternative orientations and step sequences, except where expressly specified to the contrary. It is also to be understood that the specific devices and processes illustrated in the attached drawings, and described in the following specification are simply exemplary embodiments of the concepts in the appended claims. Hence, specific dimensions, directions or other physical characteristics relating to the embodiments disclosed are not to be considered as limiting.

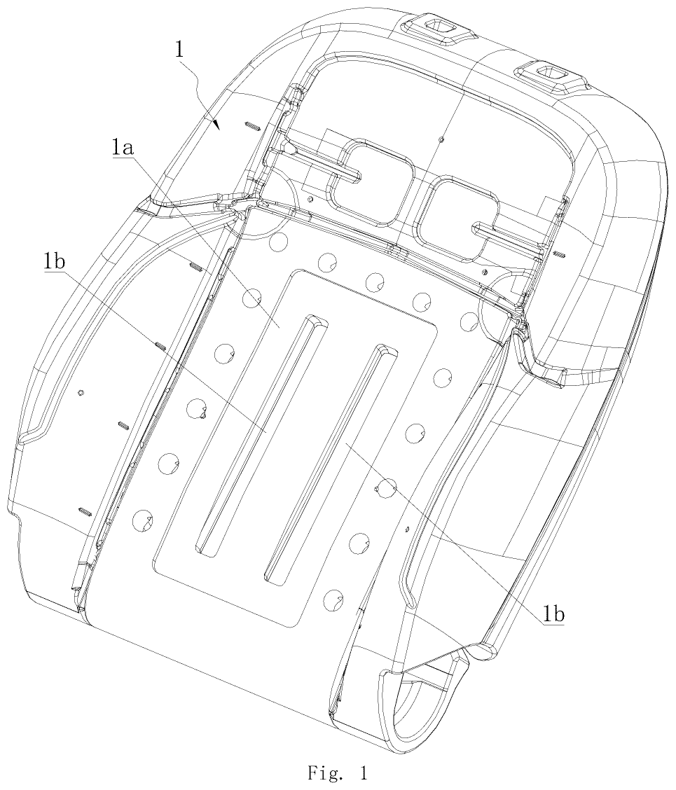

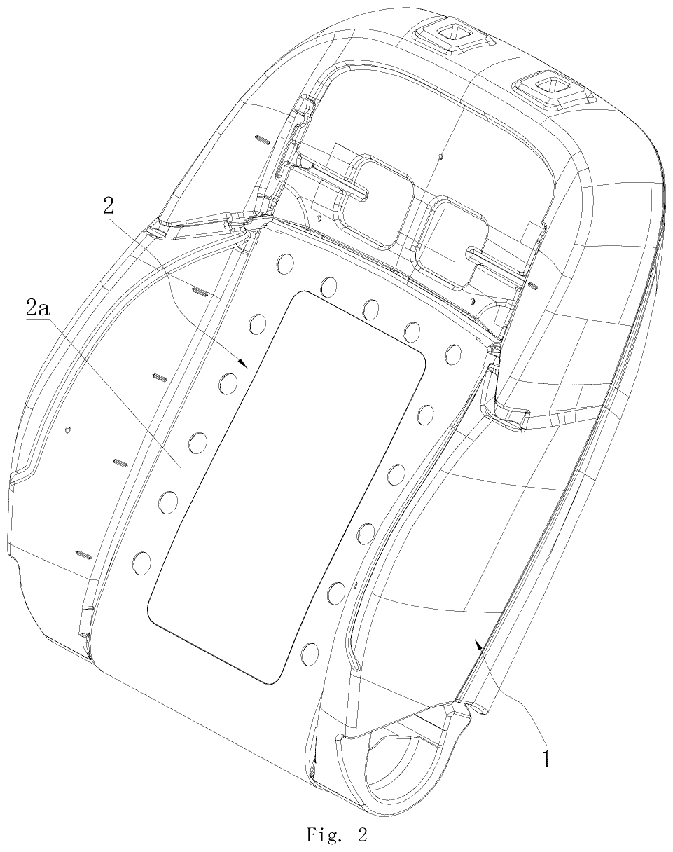

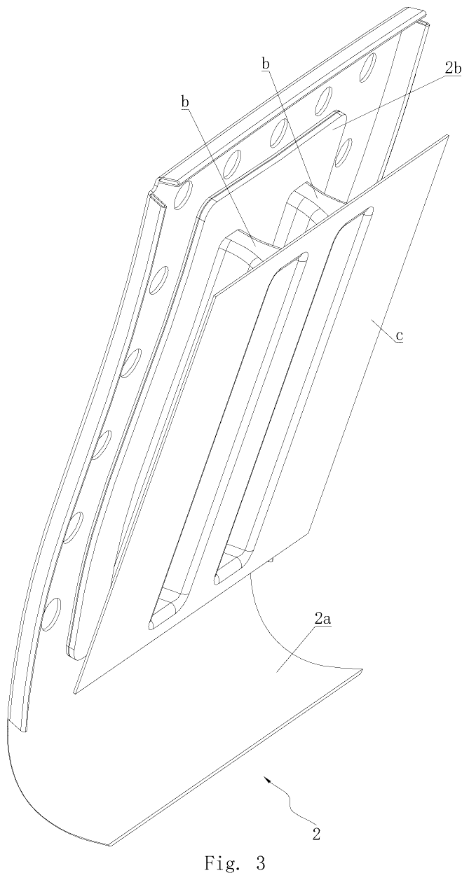

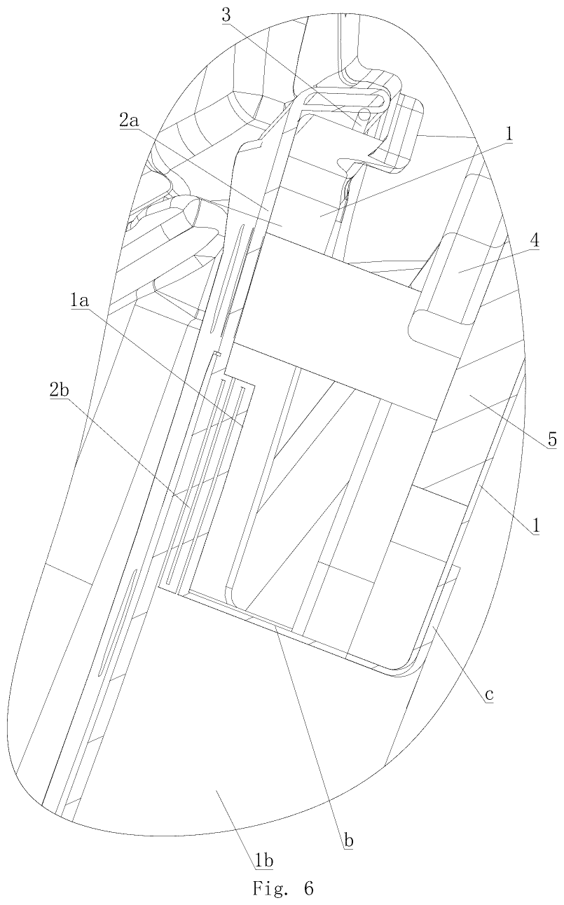

As shown in FIG. 1, a backrest cover and foam mounting structure adapted for a lumbar massage function comprises a backrest foam 1. A front surface of the backrest foam 1 is provided with a recessed area 1a. The recessed area 1a is provided with two strip-shaped through grooves 1b extending in a height direction of a backrest, and the two strip-shaped through grooves 1b are each used to accommodate a massage push arm. In this embodiment, the length of the strip-shaped through groove 1b is smaller than the length of the recessed area 1a. Further, with reference to FIGS. 2 and 3, the front side of the backrest foam 1 is provided with a wear-resistant fabric 2. The wear-resistant fabric 2 comprises a covering layer 2a covering the surface of the backrest foam 1. An elastic layer 2b is provided on the rear side of the covering layer 2a. As can be seen from FIG. 6, the elastic layer 2b is arranged in a folded manner within the recessed area 1a.

When the wear-resistant fabric 2 is pushed outward by the massage push arms in the strip-shaped through grooves 1b, the elastic layer 2b can be forced to stretch outward, enabling the wear-resistant fabric 2 to protrude outward.

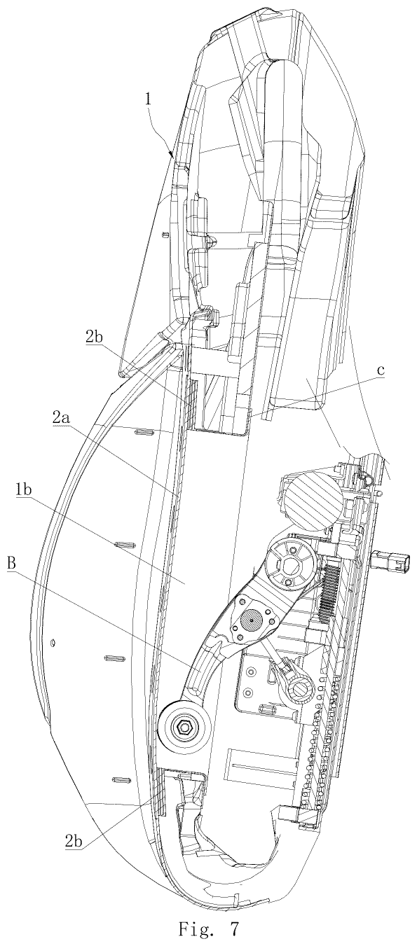

With reference to FIG. 7, when in use, the massage device is arranged inside the backrest and at a position on the rear side of the wear-resistant fabric 2. When the massage device is not in operation, the massage push arms B are retracted and stored in the strip-shaped through grooves 1b and do not press against the inner side of the wear-resistant fabric 2. At this time, it can be ensured that the covering layer 2a is in a flat state, which provides good comfort for users to lean on the seat back normally without any discomfort. When the massage function is enabled, the massage push arms B pass through the strip-shaped through grooves 1b and the elastic layer 2b of the annular structure and act on the inner side of the covering layer 2a. The inner side of the covering layer 2a is pushed forward by the massage push arms B, which causes the elastic layer 2b to stretch outward. The positions of the covering layer 2a corresponding to the massage push arms B can adaptively protrude outward without any feeling of pulling, so that it can be ensured that the massage push arms B stably perform massage operations such as kneading, tapping, and therapeutic (Tui Na) massage.

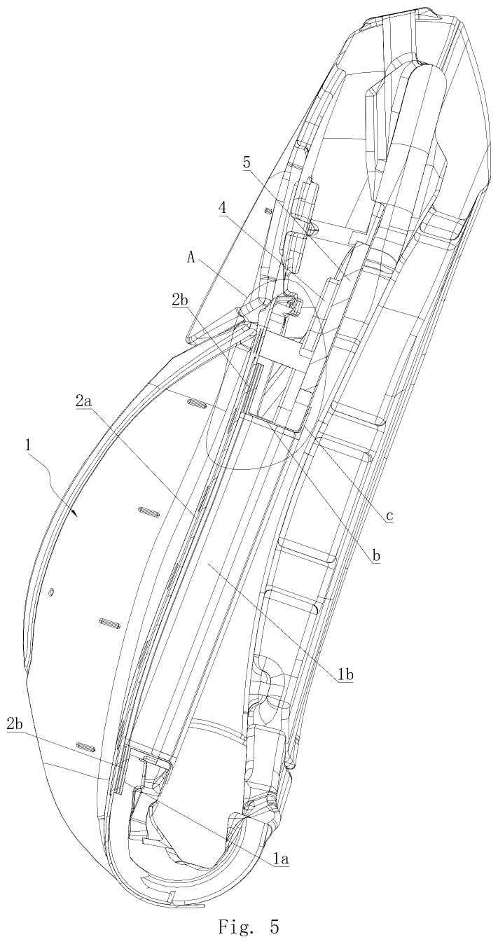

Further, as shown in FIGS. 3 and 5, the elastic layer 2b is an annular structure and is arranged along a circumferential direction of the recessed area 1a. With this design, when the massage push arms B are pressed against the inner side of the cover layer 2a, the elastic layer 2b can better stretch outward.

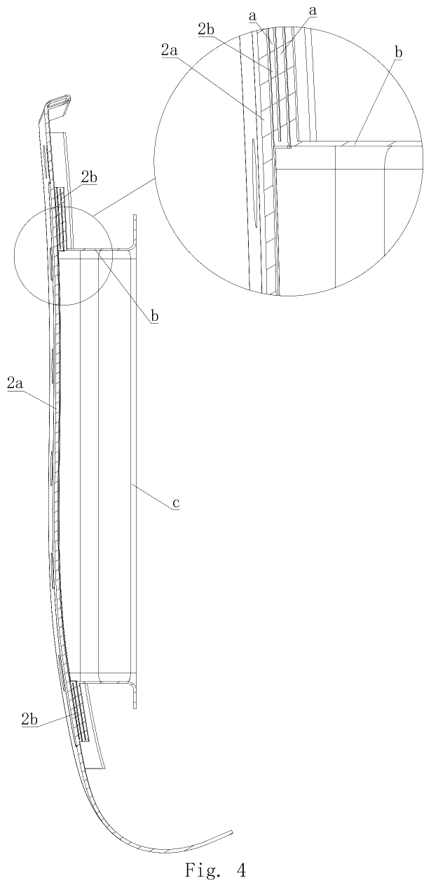

With reference to FIG. 4, the elastic layer 2b has at least two folding layers a. The outermost folding layer a is connected to the covering layer 2a. With reference to FIG. 3, the innermost folding layer a is connected with transition sections b. Two transition sections b are arranged along the width direction of the covering layer 2a, and the transition sections b are channel structures adapted to the strip-shaped through grooves 1b. With reference to FIG. 5, each transition section b is connected to the wall of the corresponding strip-shaped through groove 1b. When the massage push arms B are pushed forward, they can first act on the inner surface of the covering layer 2a through the transition sections b.

As shown in FIG. 3, an inner connecting layer c is provided at one end of the transition section b away from the elastic layer 2b. As can be seen from FIG. 5, the inner connecting layer c covers the inner surface of the backrest foam 1. It can be ensured that when the massage push arms B apply an outward thrust to the covering layer 2a, the wear-resistant fabric 2 is always fixedly connected to the backrest foam 1.

Further, as shown in FIG. 6, a steel wire 3 is embedded in the backrest foam 1, and the circumferential edge of the covering layer 2a is anchored on the steel wire 3. This design ensures the stability of the circumferential connection between the covering layer 2a and the backrest foam 1.

With reference to FIGS. 1 and 6, to ensure the flatness of the front surface of the wear-resistant fabric 2 when the massage device is not working and to improve the user's normal seating comfort, in this embodiment, the recessed area 1a is a rectangular groove that is downwardly concave, and the thickness of the elastic layer 2b is adapted to the circumferential thickness of the recessed area 1a.

In this embodiment, the wear-resistant fabric 2 has elasticity. With this design, the wear-resistant fabric 2 can return to a flat state when the massage is finished.

Further, with reference to FIGS. 5 and 6, a mesh fabric 4 and a sealing plate 5 are provided between the inner connection layer c and the inner surface of the backrest foam 1. With this consideration, the reliability and tightness of the connection between the wear-resistant fabric 2 and the inner surface of the backrest foam 1 are improved.

Finally, it should be noted that the above descriptions are only preferred embodiments. In light of the teachings, those of ordinary skill in the art can make various similar modifications without departing from the spirit and scope. Such modifications are all encompassed within the scope of protection of the present device.

What is claimed is:

1. A backrest cover and foam mounting structure adapted for a lumbar massage function, comprising a backrest foam, wherein a front surface of the backrest foam is provided with a recessed area, the recessed area is provided with two strip-shaped through grooves extending in a height direction of a backrest, and the two strip-shaped through grooves are each used to accommodate a massage push arm;
a front side of the backrest foam is provided with a wear-resistant fabric, the wear-resistant fabric comprises a covering layer covering the surface of the backrest foam, an elastic layer is provided on a rear side of the covering layer, and the elastic layer is arranged in a folded manner within the recessed area; and when the wear-resistant fabric is pushed outward by the massage push arms in the strip-shaped through grooves, the elastic layer is able to be forced to stretch outward, enabling the wear-resistant fabric to protrude outward.

2. The backrest cover and foam mounting structure adapted for the lumbar massage function according to claim 1, wherein the elastic layer is an annular structure and is arranged along a circumferential direction of the recessed area.

3. The backrest cover and foam mounting structure adapted for the lumbar massage function according to claim 1, wherein the elastic layer has at least two folding layers, the outermost folding layer is connected to the covering layer, the innermost folding layer is connected with transition sections, and the transition sections are channel structures and are connected to groove walls of the strip-shaped through grooves.

4. The backrest cover and foam mounting structure adapted for the lumbar massage function according to claim 3, wherein an inner connecting layer is provided at an end of the transition section away from the elastic layer, and the inner connecting layer covers an inner surface of the backrest foam.

5. The backrest cover and foam mounting structure adapted for the lumbar massage function according to claim 1, wherein a steel wire is embedded in the backrest foam, and a circumferential edge of the covering layer is anchored on the steel wire.

6. The backrest cover and foam mounting structure adapted for the lumbar massage function according to claim 1, wherein the recessed area is a rectangular groove that is downwardly concave.

7. The backrest cover and foam mounting structure adapted for the lumbar massage function according to claim 1, wherein the length of the strip-shaped through groove is smaller than the length of the recessed area.

8. The backrest cover and foam mounting structure adapted for the lumbar massage function according to claim 4, wherein a mesh fabric and a sealing plate are provided between the inner connecting layer and the inner surface of the backrest foam.

9. The backrest cover and foam mounting structure adapted for the lumbar massage function according to claim 1, wherein the wear-resistant fabric has elasticity.
